(19) United States
(12) Patent Application Publication
(10) Pub. No.: US 2008/0311363 A1
(43) Pub. Date: Dec. 18, 2008

(54) METAL FIBER COATED SUBSTRATE AND METHOD OF MAKING

(75) Inventors: THOMAS E. HASKETT, Oakdale, MN (US); JEFFREY M. MAILAND, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/761,871

(22) Filed: Jun. 12, 2007

(51) Int. Cl. B32B 7/02; B05D 1/12; B05D 5/10; B32B 15/04

(52) U.S. Cl. 428/212; 427/180; 427/208.6; 428/332; 428/457

(57) ABSTRACT

The disclosed metalized article comprises a substrate, a base binder, and a plurality of loose metal fibers secured to the substrate by the base binder. The method of making the disclosed metalized article comprises providing a substrate, providing a plurality of loose metal fibers on at least a portion of the substrate, and securing the metal fibers to the substrate with a base binder.

### BACKGROUND

The present invention relates to a metalized article. In particular, the present invention relates to a metalized article comprising a metal fiber coated substrate.

Metal wool pads, such as steel wool pads, have been used for a variety of household and industrial applications that require scouring or abrading a surface. Steel wool strands are used because a low cost scouring pad can be provided to consumers. One typical application for steel wool pads is in the household for scouring articles like pots and pans. The hardness of the metal and the sharp edges provide scouring action and polishes the metal surfaces of the pots and pans.

In spite of the practical applications, metal wool and in particular steel wool pads have a number of undesirable characteristics. The metal oxidizes and rusts, and metal wool pads have the tendency to shed metal fibers or splinters. The sharpness of the metal fibers makes the pad uncomfortable to hold. If contact is made with the metal wool pad, the splinters may enter the skin of the user and result in a metal sliver.

Non-woven fabric abrasive pads have also been used for cleaning and scouring. One such pad is commercially available under the trade name Scotch-Brite manufactured by 3M Company of St. Paul, Minn. Typically, such an abrasive pad can be manufactured by a method disclosed in U.S. Pat. No. 2,958,593 (Hoover et al.). These non-woven pads are effective during cleaning for removing material such as food and stains from a surface. However, these pads are not as effective at polishing materials such as metal.

### SUMMARY

The disclosed metalized article comprises a substrate, a base binder layer, and a plurality of loose metal fibers secured to the substrate by the base binder layer. In one embodiment, the metalized article is effective for scouring and polishing a surface, typically a metal surface, during cleaning. In one embodiment, the metal fibers are independent from one another. In one embodiment, the scouring article further comprises a securing binder layer covering at least a portion of the metal fibers. In one embodiment, the scouring article comprises abrasive particles secured to the securing binder layer or to the base binder layer. In one embodiment, the abrasive particles comprise soft large-sized particles. In one embodiment, the abrasive particles comprise hard small-sized particles. In one embodiment, the abrasive particles comprise soft large-sized particles and hard small-sized particles.

### BRIEF DESCRIPTION OF THE DRAWINGS

FIG. 1a is a perspective view of one embodiment of a metalized article;

FIG. 1b is an enlarged side section view of the metalized article of FIG. 1a;

FIG. 2 is an enlarged side section view of an alternative embodiment of a metalized article;

FIG. 3 is an enlarged side section view of an alternative embodiment of a metalized article;

FIG. 4 is a perspective view of an alternative embodiment of a metalized article;

FIG. 5 is a perspective view of an alternative embodiment of a metalized article.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

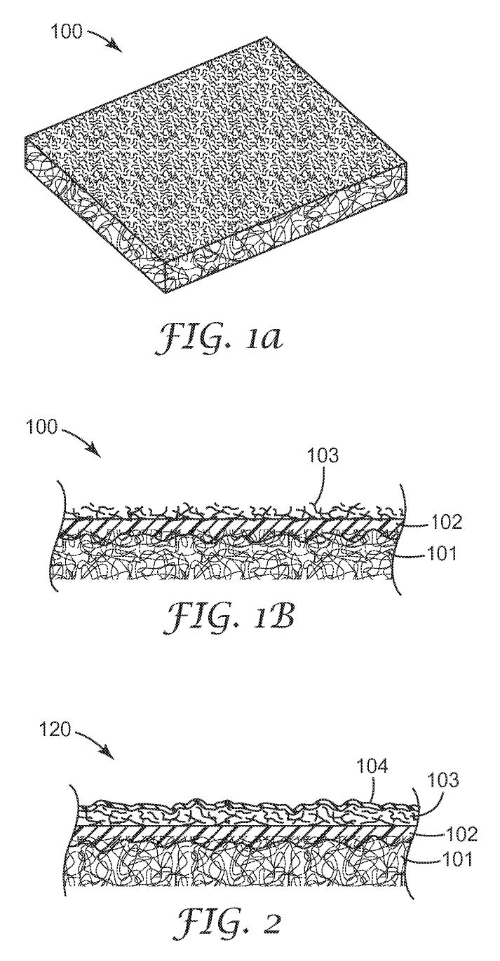

The metalized article comprises a substrate, a base binder, and metal fibers secured to the substrate by the base binder. FIG. 1a is a perspective view of one embodiment of a metalized article 100 and FIG. 1b is an enlarged side section view of the metalized article 100 of FIG. 1a. The metalized article 100 comprises a substrate 101 with metal fibers 103 secured to the substrate with a base binder 102. In this embodiment, the base binder 102 is coated over the substrate surface. The base binder 102 secures the metal fibers 103 to the substrate 101.

FIG. 2 is an enlarged side section view of another embodiment of a metalized article 120. The metalized article 120 comprises a substrate 101 with metal fibers 103 secured to the substrate with a base binder 102. In this embodiment, the base binder 102 is coated over the substrate 101 surface. In this embodiment, the metalized article 120 further comprises a securing binder 104 covering at least a portion of the metal fibers 103. The securing binder 104 further secures the metal fibers 103 to the substrate to prevent the metal fibers 103 from disengaging from the substrate 101. Additionally, the securing binder 104 inhibits corrosion of the metal fibers 103.

FIG. 3 is an enlarged side section view of another embodiment of a metalized article 130. The metalized article 130 comprises a substrate 101 coated with a base binder 102 and metal fibers 103 secured to the base binder 102. Covering at least a portion of the metal fibers 103 is a securing binder 104. The securing binder 104 further secures the metal fibers 103 to the substrate to prevent the metal fibers 103 from disengaging from the substrate 101. In this embodiment, the metalized article 130 further comprises abrasive particle dispersed throughout the securing binder 104. In this embodiment, the abrasive particles comprise small-hard particles 106 and large-soft particles 107.

The substrate 101 provides structural support for the metal fibers 103. The substrate 101 may be made of any material that can provide structural support to the metal fibers 103. The substrate may be made from synthetic or natural materials, which may or may not be degradable.

Suitable substrates include woven, knitted, or nonwoven materials made of natural, synthetic, or a combination of natural and synthetic fibers. Natural fibers may include cotton, linen, soybean, bamboo, hemp or other fiber forming natural fiber or combinations thereof. Synthetic fibers may be made from fiber forming polymers or regenerated cellulose. Suitable polymers can be selected from polyesters(such as polyethylene terephthalate), polyamides(such as nylon 6, nylon 6/6, and nylon 10), polyimides, nylon, polyolefins (e.g., polyethylenes, polypropylenes, and polybutylenes), poly(ethylene vinyl alcohol) (PEVOH), poly (propylene vinyl alcohol) (PPVOH), polylactic acid (PLA), or combinations thereof Other fibers include semi-synthetic fibers such as acetate fibers and regenerated fibers such as rayon.

The substrate 101 shown in the embodiments of FIGS. 1a, 1b, 2, and 3 is a nonwoven. One example of a suitable nonwoven is a Scotch-Brite® Scouring Pad available from 3M Company of St. Paul, Minn. In another embodiment, the nonwoven web substrate may comprise a metal fiber web or a web comprising a blend of polymeric fibers and metal fibers. US patent applications 2007/0079462 and 2007/0079919 titled “Scouring Web and method of Making,” and PCT patent application US 2007/0066076 titled “Scouring Web,” filed on Apr. 5, 2007, all herein in incorporated by reference, disclose webs, which may include a web of polymeric and metal fibers, that may be suitable as the substrate 101 of a metalized article.

Other suitable substrates include fiberglass, scrim or netting, film, paper, open-cell or closed-cell foam, foamed latex rubber, or sponge. FIG. 4 is a perspective view of another embodiment of a metalized article 140. In this embodiment the metalized article 140 includes a substrate 101 that is foam. Metal fibers 103 are secured to the substrate 101 by a base binder 102. In this embodiment, the base binder 102 covers a portion of the substrate 101. Additionally, FIG. 4 shows the substrate 101 with a geometry, as opposed to the embodiment of FIG. 1a where the substrate is generally planar. It is believed that the geometry provides greater ability of compression of the substrate in a localized area such that the pressure in that localized area is increased to increase the scouring and polishing ability. In this embodiment, the substrate has recesses, which create raised areas. In this embodiment, the raised areas and recesses are separated from one another and extend from edge to edge of the substrate. In this embodiment, the metal fibers 103 are only positioned on the raised areas.

It is understood that any shape or configuration of surface geometry on the substrate may be included. For example, the raised areas may be circles, squares, triangles such that the recesses are interconnected. Also, it is understood that the metal fibers may be positioned on the entire surface or portions of the surface of the substrate. For example, the metal fibers maybe only in the recess, only on the raised area, covering the recess and raised area, or a combination thereof. Although the surface geometry has been shown on a foam substrate, it is understood that a variety of substrate may be incorporated with a surface geometry.

The substrate may be flexible and drapeable. The substrate may be stiff and relatively rigid. The substrate may be hydrophobic or hydrophilic. The substrate may be preloaded with detergent, soap, emollient, polishers, bleach, perfumes, colorants, antibacterial, antimicrobial, or antifungal chemicals or other known types of materials. These additional components may be encapsulated and carried within the substrate or may be encapsulated and separately applied with one or more of the binder layers.

On a surface opposite the surface containing the metal fibers, the substrate may include a fastener. In one embodiment, the surface opposite the surface containing the metal fibers may be coated with an adhesive such as a permanent adhesive, a pressure sensitive adhesive, or a repositionable pressure sensitive adhesive. In another embodiment, the surface may include a mechanical fastener such as hooks, loops or mating with receiving hooks or loops. The fastener serves to secure the metalized article to another surface. In one embodiment, the substrate may be a paper or film so that the metalized article having the adhesive forms a tape or label.

The base binder 102 secures the metal fibers 103 to the substrate. In one embodiment, the base binder 102 can be applied in any number of patterns to the substrate so that an entire surface of a substrate 101 is coated or only a portion of a surface of a substrate 101 is coated. In another embodiment, the metal fibers 103 are positioned on the substrate 101 and the base binder 102 is applied over the metal fibers 103. In another embodiment, the metal fibers 103 can be included into the base binder 102 and applied to the substrate simultaneously. In one embodiment, the base binder 102 can serve to secure abrasive particles, if included.

The securing binder 104, if included, covers at least a portion of the metal fibers 103 and can serve to further secure the metal fibers 103 to the substrate 101 to prevent the metal fibers from falling off the substrate. The securing binder 104 inhibits corrosion of the metal fibers 103. Additionally, the securing binder 104 can serve to secure abrasive particles, if included. Although it was believed that an overlying securing binder layer 104 would detrimentally impact the metal fiber's ability to polish a metal surface, it was surprisingly found that the metal fiber maintained its ability to polish a metal surface even when coated with a securing binder.

The base binder 102 and the securing binder 104 (if included) are applied as a coating. It is understood that although the side sectional views (FIGS. 1b, 2, and 3) show the binders as somewhat of a layer, the binders will penetrate a certain extent into the substrate and/or metal fibers. The extent to which the binders penetrate depends on the openness of the substrate and/or metal fibers and the viscosity of the binder. In one embodiment, one, two, or more of the binders will form a layer.

For both the base binder 102 and the securing binder 104, the binder may be an adhesive agent. The adhesive agent contains a binder resin and an additive as a component. In one embodiment, the binder resin typically is an organic resin offering the function of bonding a substance by the change of a coatable liquid to a stiff solid. Also, an adhesive agent precursor particularly means an adhesive agent in a liquid state. The adhesive agent can be a thermosetting adhesive agent such as an aqueous suspension or an organic solvent solution of epoxy, melamine, phenol, urethane, isocyanate and isocyanurate resins, or a rubber-based polymer solution or suspension such as SBR, SBS and SIS. These adhesive agents are applied by immersion coating, roll coating, spray coating and the like. In another embodiment, the binder may be degradable. Examples of degradable binders include PVA, starch based, or solution based on PHA and PLA.

For both the base binder 102 and the securing binder 104, these binder may be particularly applied so as to achieve a pattern coating of the metal fibers 103, the abrasive particles (if included) or both. Additionally, it is understood that the base binder and securing binder may be the same type of material or may be different materials.

The metal fibers 103 can include any type of metal fibers such as but not limited to steel, stainless steel, copper, brass, gold, silver (which has antibacterial/antimicrobial properties), platinum, bronze or blends of one or more of various metals. In one embodiment, the metal fibers 103 may formed by chopping into discrete length a tow of metal fibers. In another embodiment, the metal fibers 103 may be formed by skiving metal fibers from a metal block. In another embodiment, the metal fibers 103 may be formed from cut sections of a metal film. In any case, the metal fibers 103 may have a variety of geometries. For example, the metal fibers may have a ribbon-like geometry. In another embodiment, the metal fibers may have a uniform or non-uniform rectangular cross-section. In another embodiment, the metal fibers may be tubular-like shape. In one embodiment, it may be desirable to crimp the metal fibers.

In one embodiment, the metal fibers 103 can be fibers having a length greater than 0.5 inches (1.27 cm). In another embodiment, the metal fibers 103 may be fractured or ground fibers having sizes ranging from micron sized to 0.5 inches (1.27 cm) in length. In one embodiment, the metal fibers 103 have a thickness from 25 to 90 microns. In one embodiment, stainless steel is used because it is harder than other metal fibers like copper and bronze and is more corrosion resistant than steel wool.

Typically, stainless steel has been a preferred material because of its scouring and polishing ability and because it does not rust. However, stainless steel is relatively expensive compared to steel wool, for example. Because the metalized article includes a coating of metal fibers 103, the amount of metal fibers 103 used is relatively small as compared to pure metal fiber webs, like steel wool pads, or metal/polymeric webs. A coating of metal fibers 103 allows for incorporation of a small amount of metal onto a variety of substrates for a low cost scouring article which is capable of providing both scouring and polishing. In embodiments, such as that shown in FIGS. 2 and 3, although a securing binder is included and covers at least a portion of the metal fibers, the metalized article surprisingly maintains its ability to scour and polish a surface, such as a metal cooking pan.

In one embodiment, the metal fibers 103 included typically are loose fibers. Loose fibers means the metal fibers are not fastened together prior to securing to the substrate. In one embodiment, the metal fibers 103 themselves do not form a web. In one embodiment, the metal fibers 103 form an interconnected web prior to securing to the substrate. The metal fibers 103 are secured to the substrate by the base binder.

Abrasive particles may be included (see FIG. 3). In one embodiment, the abrasive particles may be soft particles 107, hard particles 106, or a mixture of soft particles 107 and hard particles 106. Soft particles 107 have a Mohs hardness within a range of 1 to 7, preferably 2 to 4. A Mohs hardness of less than 1 in soft particles 107 may bring insufficient abrasive power to the scouring article, while a Mohs hardness of more than 7 therein may bring the possibility of scratching a surface to be polished. In one embodiment, the material of soft particles 107 is an inorganic material such as garnet, flint, silica, pumice stone and calcium carbonate, an organic polymer material such as melamine, polyester, polyvinyl chloride, methacrylate, methyl methacrylate, polycarbonate and polystyrene, and the like.

In one embodiment, soft particles 107 have a large size as compared with hard particles 106. For example, the particle diameter of soft large-sized particles 107 is 10 to 1000 times, preferably 30 to 100 times the particle diameter of hard small-sized particles 106.

In one embodiment, the average particle diameter of soft large-sized particles 107 is 0.1 to 1 mm, preferably 0.1 to 0.3 mm. An average particle diameter of less than 0.1 mm in soft large-sized particles 107 may bring difficulty in removing thick debris, such as scorching, while an average particle diameter of more than 1 mm therein may bring difficulty in holding themselves properly.

In one embodiment, hard particles 106 have a Mohs hardness within a range of 8 or more, preferably 8 to 9. A Mohs hardness of less than 8 in hard particles 106 may bring a weak function of removing hard and thin film-like debris. In one embodiment, the material of hard particles 106 is silicon carbide, aluminum oxide, topaz, fusion alumina-zirconia, boron nitride, tungsten carbide, silicon nitride and the like.

In one embodiment, the average particle diameter of hard small-sized particles 106 is 1 to 10 μm, preferably 2 to 7 μm. An average particle diameter of less than 1 μm in hard small-sized particles 106 typically is insufficient at removing hard and thin film-like debris, while an average particle diameter of more than 10 μm may tend to scratch the surface.

When both soft large-sized particles 107 and the hard small-sized particles 106 are included, the ratio of the soft large-sized particles 107 and the hard small-sized particles 106 is useful in the range of from 1:9 to 9:1. If the soft large-sized particles 107 are larger in quantity than this range, it becomes difficult to remove hard and thin film-like debris, whereas if the hard small-sized particles 106 are larger in quantity than the range, it becomes difficult to remove soft and thick debris, such as food scorch. In one embodiment, a combination range is that the soft large-sized particles 107 are larger in quantity than a combination ratio of 2:8.

Both soft large-sized particles 107 and hard small-sized particles 106 are disclosed as one example of abrasive particles that may be used with the scouring article. However, individually soft large-sized particles 107 may be used or hard small-sized particles 106 may be used. Also, it is understood that any other type, size, and hardness and various combinations thereof of particles 105 may be used with the scouring article.

Additionally, in one embodiment, after the binder (base or securing) is cured the binder has substantially the same hardness as soft large-sized particles 107. If the hardness of the binder is substantially lower than that of soft large-sized particles 107, then the binder covers up the soft large-sized particles 107. If the hardness of the binder is substantially higher than that of soft large-sized particles 107, then a surface to be polished is possibly scratched.

Additionally, in one embodiment, the metalized article may include one type of abrasive particles 105 on one portion and a second type of abrasive particles 105 on a separate portion. For example, one embodiment may has one side of the substrate 101 comprising soft large-particles 107, while another side of the substrate 101 comprises hard small-particles 106.

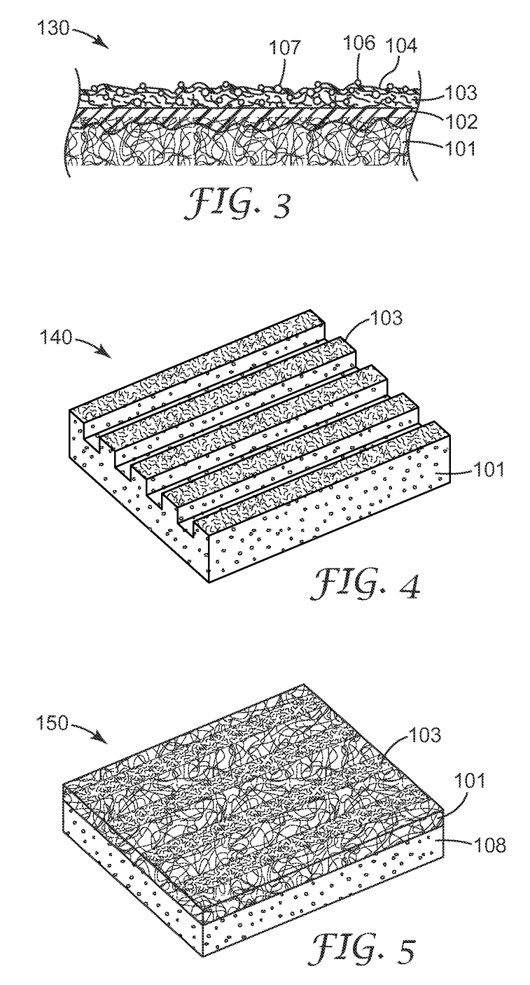

The metalized article may be used alone or in combination with various other substrates. FIG. 5 shows a perspective view of another embodiment of a scouring article 150. In this embodiment, the scouring article 150 includes a nonwoven substrate 101 covered in striped, discrete portions by metal fibers 103 which are secured by the base binders 102 to create discrete, striped sections of metal and nonmetal areas on a single surface of the substrate 101. Further, the metalized article 150 is further secured to an additional substrate 108 by any known securing means. In this embodiment, the additional substrate is foam. However, it is understood that any of the above mentioned substrates 101 may be used as the additional substrate 108.

It is understood that any metalized article (one, two, or more layers) may include a pattern coating of the metal fibers 103. Also, it is understood, that any number of layers of substrates may be included. Additionally, the metalized article may have one or two or any number of its surfaces, including all of its surfaces covered with metal fibers.

The metalized article is particularly suitable as a cleaning, scouring, or abrading surface. To use the metalized article to scour a surface, a user may use the metalized article to contact the surface to be scoured. The user may hold the metalized article with his or her hand or may attach the metalized article to a handled tool. The metalized article may be used to scour, abrade, or polish any number of surfaces. Particularly, the metalized article may be used to scour, abrade, or polish surfaces that are accommodating to steel wool pads or other such metal pads. Such surfaces include, but are not limited to metal and wood surfaces. One particular application of the scouring article includes scouring metal surfaces such as pots, pans, and other kitchenware. In such an instance, the metalized article scours and removes debris from the surface and polishes the metal. In one embodiment, the metal fibers included on the metalized article are corrosion resistant and will not rust. Use of the metalized article comprising metal fibers 103 along with the abrasive particle provides a metalized article with enhanced abilities to scour and polish a surface, especially for cleaning applications.

Although one suitable application is a scouring article, the article may be used for wood refinishing. Additionally, the metalized article may be used for microwave packaging, electronic shielding, sound absorbing, heat reflecting, anti-static, air or water filtration or as a conductive substrate.

The metalized article may be made in a variety of ways. The substrates are made by known means. In one embodiment, the base binder is coated onto the substrate by known coating means such as spray coating, roll coating, or immersion coating. Alternatively, the metal fibers are applied to the substrate and the base binder is coated onto the substrate and metal fibers by know means. In one embodiment, the metal fibers as incorporated into to the base binder and applied to the substrate simultaneously. Additionally, in one embodiment, the metal fibers may be heated and when applied to a meltable substrate, melt the substrate. In this embodiment, the melted substrate will resolidify and will further secure the metal fibers to the substrate.

The metal fibers are applied on to the substrate, which may or may not include the base binder. US patent application 2005/0098910, herein incorporated by reference, discloses one suitable method for dropping metal fibers on to a substrate. Another suitable method for dropping metal fibers on to a substrate may be to use a method similar to that shown and described in U.S. Pat. No. 4,118,531. In one embodiment, a magnetic field or electromagnetic field may be used to orient or pull the metal fibers into open areas of the web or to control distribution of the metal fibers on the substrate.

In one embodiment, an additional securing binder is coated over at least a portion of the metal fibers by known coating means such as spray coating, roll coating, or immersion coating.

The optional abrasive particles may be included with the base binder or securing binder or may be separately applied prior to curing of either the base binder or securing binder.

If either the base binder or securing binder is a thermosetting resin, the binder is heated to cure. In one embodiment, the thermosetting resin heated to a temperature of 100 to 300° C. for 10 to 30 minutes.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

### EXAMPLES

### A. Metalized Nonwoven Web

1. The substrate of the metalized article is a nonwoven web made by processing 15 denier DuPont® Nylon Type 852 fibers. A 250 gsm (grams per square meter), 380 mils, lofty nonwoven web was prepared using an air lay machine available under the trade designation “RANDO WEBBER” from Rando Machine Corp., Macedon, N.Y.

2. The substrate from 1 was roll coated with 300 gsm (wet) of the following resin solution:
16% water
80% urethane resin, W835/394, Incorez, USA
3.2% hardener, Carbodilite, SV-02 from Nisshimbo Industries of Japan
0.8% pigment

3. Continuous filament type OO steel wool metal fiber, from Global Materials Technologies of Palatine, Ill. was ground through a #20 sieve (850 micron openings) on to the wet surface of the substrate from 2 to a weight of 50 gsm metal fiber add on. The substrate was dried and cured for 10 minutes at 300° F. (149° C.).

4. The substrate from 3 was then spray coated with 225 gsm (wet) of the following resin solution. The substrate was dried for 10 minutes and cured at 300° F. (149° C.).
36% water
60% urethane resin, W835/394, Incorez, USA
2.4% hardener, Carbodilite, SV-02 from Nisshimbo Industries of Japan
0.6% pigment

5. The substrate from 4 awas then spray coated with 300 gsm (wet) with the following resin and abrasive particle solution. The substrate was dried and cured for 10 minutes at 300° F. (149° C.).
15.7% water
39.3% urethane resin, W835/394, Incorez, USA
1.6% hardener, Carbodilite, SV-02 from Nisshimbo Industries of Japan
0.6% pigment
7% 8000 grit SiC mineral, from Fujimi Corp. of Tualatin, Oreg.
20% melamine mineral made from ground recycled melamine, from Media Blast

### B. Metalized Urethane Foam

1. The substrate for the metalized article is a 0.5 inch (12.7 mm) urethane foam (41 lbs/ft³ density), available from Illbruck is spray coated with a 225 gsm (wet) of the following resin solution:
16% water
80% urethane resin dispersion, W835/394 Incorez, USA
3.2% hardener, Carbodilite, SV-02, from Nisshimbo Industries of Japan
0.8% Pigment

2. Continuous filament “00” steel wool metal fiber from Global Metal Technologies of Palatine, Ill. is ground through a #20 Sieve (850 micron openings) onto the wet surface of the foam from 1 to a weight of 50 gsm metal fiber add on. This grinding action fractures the metal fibers and forces them through the screen.

3. The foam from 2 is then electro-static spray coated or drop coated with 50 gsm of melamine mineral over the metal fiber and the web is dried and cured for 10 minutes at 300° F. (149° C.).

4. The foam from 3 is then spray coated with an optional 300 gsm (wet) coat of the following resin solution to enhance metal polishing and corrosion resistance. The resin is cured for 10 minutes at 300° F. (149° C.):
16% water
73% urethane resin dispersion, W835/394 Incorez, USA
3.2% hardener, Carbodilite, SV-02, from Nisshimbo Industries of Japan
0.8% Pigment
7% 8000 grit SiC mineral, from Fujimi Corp. of Tualatin, Oreg.

What is claimed is:

1. A metalized article comprising:
a substrate;
a base binder;
a plurality of loose metal fibers secured to the substrate by the base binder.

2. The metalized article of claim 1, wherein the substrate is selected from the group consisting of woven, knitted, nonwoven, foam, sponge, film, paper, or combinations of one or more thereof.

3. The metalized article of claim 1, wherein the substrate is further secured to an additional layer.

4. The metalized article of claim 3, wherein the additional layer is selected from the group consisting of woven, knitted, nonwoven, foam, sponge, film, paper, or combinations of one or more thereof.

5. The metalized article of claim 1, wherein the metal fibers are selected from the group consisting of steel, steel wool, stainless steel, copper, silver, gold, or combinations of one or more thereof.

6. The metalized article of claim 1, wherein the metal fibers are independent from one another.

7. The metalized article of claim 1, wherein the base binder covers at least a portion of the substrate.

8. The metalized article of claim 1, wherein the base binder covers at least a portion of the metal fibers.

9. The metalized article of claim 1, further comprising a securing binder covering at least a portion of the metal fibers.

10. The metalized article of claim 9, further comprising abrasive particles secured to the securing binder.

11. The metalized article of claim 10, wherein the abrasive particles comprise soft large-sized particles with a diameter from 0.1 to 1 mm and a Mohs hardness from 2 to 4.

12. The metalized article of claim 10, wherein the abrasive particles comprise hard small-sized particles with a diameter from 1 to 10 μm and a Mohs hardness at least 8.

13. The metalized article of claim 10, wherein the abrasive particles comprise soft large-sized particles and hard small-sized particles.

14. The metalized article of claim 13, wherein a particle diameter of the soft large-sized particles is 10 to 1000 times a particle diameter of the hard small-sized particles.

15. The metalized article of claim 13, wherein a Mohs hardness of the soft large-sized particles is 2 to 4 and a Mohs hardness of said hard small-sized particles is 8 or more.

16. A metalized article comprising:
a substrate;
a base binder;
a plurality of metal fibers secured to the substrate by the base binder;
a securing binder covering at least a portion of the metal fibers.

17. The metalized article of claim 16, further comprising abrasive particles secured to the securing binder.

18. A scouring article comprising:
a substrate;
a base binder covering at least a portion of the substrate;
a plurality of metal fibers secured to the base binder;
a securing binder covering at least a portion of the metal fibers; and
abrasive particles secured to the securing binder.

19. A method of making a metalized article comprising:
providing a substrate;
providing a plurality of loose metal fibers on at least a portion of the substrate;
securing the metal fibers to the substrate with a base binder.

20. The method of claim 19, further comprising coating at least a portion of the substrate with the base binder and securing the metal fibers to the base binder.

21. The method of claim 19, further comprising coating the metal fibers with the base binder to secure the metal fibers to the substrate.

22. The method of claim 19, further comprising:
coating at least a portion of the metal fibers with a securing binder.

23. The method of claim 19, further comprising:
dispersing abrasive particles throughout the metalized article.

24. The method of claim 19, further comprising:
directing the metal fibers on to the substrate with a magnetic field.
